(19) United States
(12) Patent Application Publication
(10) Pub. No.: US 2013/0269553 A1
(43) Pub. Date: Oct. 17, 2013

(54) SCREEN PRINTING DEVICE SCRAPER

(71) Applicant: Yoichiro Nishimoto, Chiyoda-ku (JP)

(72) Inventor: Yoichiro Nishimoto, Chiyoda-ku (JP)

(21) Appl. No.: 13/997,281

(22) PCT Filed: Dec. 27, 2010
(86) PCT No.: PCT/JP2010/073566

§ 371 Date: Jun. 24, 2013

(51) Int. Cl. B41F 15/08

(52) U.S. Cl. CPC B41F 15/0818
USPC 101/123

(57) ABSTRACT

A scraper central portion in which a first contact surface has a trapezoidal shape with a lower base longer than an upper base, and scraper end portions that extend and are bent from respective lateral sides of a trapezoidal shape of the scraper central portion to a side of the first contact surface, and that include second contact surfaces that come in contact with the coating material. A lower base of the scraper central portion and lower sides of the scraper end portions are on the same plane. In a state where the first contact surface is vertical to the surface of the screen plate, the lower base of the scraper central portion and the lower sides of the scraper end portions come in contact with the coating material on the surface of the screen plate, and slide on the surface of the screen plate.

### FIELD

The present invention relates to a scraper for a screen printing device.

### BACKGROUND

In a screen printing device, first, a paste or ink coating material supplied on a screen plate is coated by a scraper evenly over the screen plate. A squeegee is then brought into contact with the screen plate and moved thereon, thereby printing a predetermined pattern on a printed material under the screen plate (see, for example, Patent Literature 1 and Patent Literature 2).

However, when such a scraper is used to repeat screen printing, the paste or ink coating material on the screen plate flows over and around both ends in the width-direction of the scraper to outside thereof. According to Patent Literature 1, it is supposed that the cause of this is that when both end portions of a scraper are solely bent inward relative to a traveling direction of the scraper, a coating material at the both end portions of the scraper only rolls up and down along a screen plate repeatedly, and therefore is not brought near a printing pattern portion on the screen plate.

The coating material flowing over and around the both ends of the scraper to the outside is left for a long time during an operation of the screen printing device. Therefore, due to causes such as significant changes in the viscosity by vaporization of volatile components of the coating material, the coating material cannot be reused. Accordingly, the flow of the coating material over and around the both ends of the scraper becomes a cause of the material loss.

Therefore, in order to solve this problem, there is proposed a screen printing device scraper that can reduce the material loss by reducing a flow amount of a coating material (see, for example, Patent Literature 1, Patent Literature 2, Patent Literature 3, and Patent Literature 4). For example, in Patent Literature 1, a member including an upwardly-inclined portion is attached to both ends of a scraper, thereby reducing a flow of a coating material from the both ends of the scraper. In Patent Literature 2, a sub-scraper is provided, thereby reducing a flow of a coating material over and around both ends of a scraper. In Patent Literature 3, individually-formed members are coupled with a predetermined gap therebetween, thereby reducing a flow of a coating material over and around both ends of a scraper. In Patent Literature 4, a pre-squeegee is provided to serve as a sub-scraper, thereby reducing a flow of a coating material over and around both ends of a scraper.

### CITATION LIST

### Patent Literatures

Patent Literature 1: Japanese Patent Application Laid-open No. 2004-174736
Patent Literature 2: Japanese Patent Application Laid-open No. 2004-160891
Patent Literature 3: Japanese Patent Application Laid-open No. 2005-305909
Patent Literature 4: Japanese Patent Application Laid-open No. 2007-062018

### SUMMARY

### Technical Problem

However, the techniques in Patent Literatures 1 to 4 relate to improvements by means of additionally providing a new member to a conventional scraper or screen printing device. Therefore, there is a problem of a lack of structural simplicity and cost increases.

The present invention has been achieved to solve the above problems, and an object of the present invention is to provide a screen printing device scraper that can reduce a flow of a coating material to outside of the scraper and that can be achieved with a simple structure at a low cost.

### Solution to Problem

There is provided a scraper according to an aspect of the present invention for a screen printing device that slides in a predetermined direction over a surface of a flat screen plate on which a coating material is supplied to coat the coating material on the surface of the screen plate, the screen printing device scraper including: a scraper central portion in which a first contact surface that comes in contact with the coating material has a trapezoidal shape with a lower base longer than an upper base; and scraper end portions that extend and are bent from respective lateral sides of a trapezoidal shape of the scraper central portion to a side of the first contact surface, and that include second contact surfaces that come in contact with the coating material, wherein a lower base of the scraper central portion and lower sides of the scraper end portions are on a same plane, and in a state where the first contact surface is vertical to the surface of the screen plate, the lower base of the scraper central portion and the lower sides of the scraper end portions come in contact with the coating material on the surface of the screen plate, and slide on the surface of the screen plate.

### Advantageous Effects of Invention

According to the present invention, it is possible to obtain a screen printing device scraper that can reduce the loss of a coating material by reducing a flow of the coating material over and around both end portions of the scraper to outside thereof and that can be realized with a simple structure at a low cost.

### BRIEF DESCRIPTION OF DRAWINGS

FIG. 1 is a perspective view of an external appearance of a screen printing device scraper according to a first embodiment of the present invention.

FIG. 2 is a schematic diagram for explaining a force applied to a coating material scraped by scraper end portions in the scraper according to the first embodiment.

FIG. 3 is a perspective view of an external appearance of a conventional general scraper.

FIG. 4 is a perspective view of an external appearance of a scraper in which a conventional general scraper is combined with a technique described in Japanese Patent Application Laid-open No. 4-341846.

FIG. 5 is an explanatory diagram of a force applied to a coating material scraped near a boundary between a scraper central portion and scraper end portions in the scraper according to the first embodiment.

FIG. 6 is an explanatory diagram of a force applied to a coating material scraped near a boundary between a scraper central portion and scraper end portions in a scraper 12.

FIG. 7 is a perspective view of an external appearance of a screen printing device scraper according to a second embodiment of the present invention.

### DESCRIPTION OF EMBODIMENTS

Exemplary embodiments of a screen printing device scraper according to the present invention will be explained below in detail with reference to the accompanying drawings. The present invention is not limited to the embodiments.

### First Embodiment

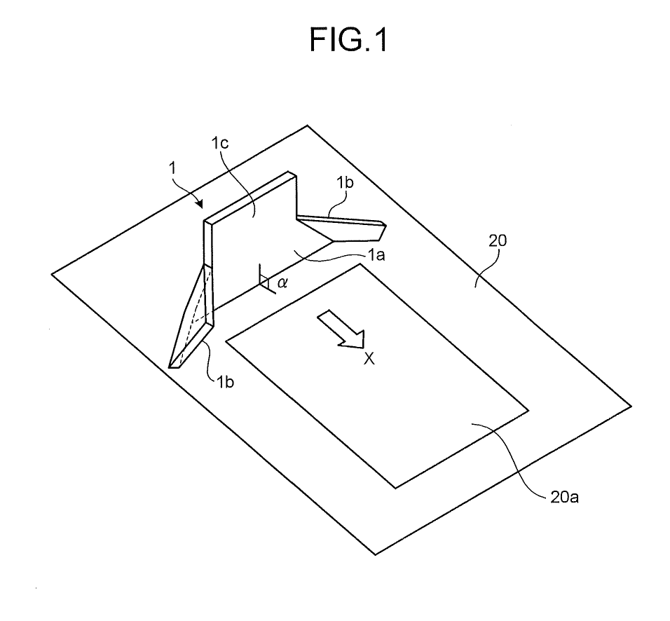

FIG. 1 is a perspective view of an external appearance of a screen printing device scraper 1 according to a first embodiment of the present invention. In the scraper 1 according to the first embodiment, scraper end portions 1b provided at both end portions of the scraper 1 are formed integrally with a scraper central portion 1a provided at the center of the scraper 1. Specifically, the scraper 1 is formed integrally by using one metal plate of stainless steel or the like, for example. The scraper 1 is used in a state where the scraper central portion 1a is set vertically to a screen plate 20. The material of the scraper 1 is not limited to metal, and other materials such as a resin material can also be used as long as the scraper 1 can function as a scraper.

The scraper central portion 1a has a trapezoidal shape defined by two lateral sides that form an inverted-V shape widening toward the bottom and by an upper base and a lower base that respectively connect between apexes of the lateral sides. That is, the scraper central portion 1a has a trapezoidal shape with the lower base longer than the upper base. The scraper central portion 1a is formed with its lower-base width corresponding to the width of a printing pattern portion 20a of the screen plate 20. On the upper base of the scraper central portion 1a, an attachment portion 1c attached to a scraper holder (not shown) that attaches the scraper 1 to the screen printing device is provided to extend upward in the plane direction of the scraper central portion 1a. In the scraper central portion 1a, a surface on a traveling direction X side of the scraper 1 is a surface that comes in contact with a coating material (first contact surface). When the scraper central portion 1a is set on the screen plate 20, an attack angle α that is an angle formed between the first contact surface and the screen plate 20 is 90 degrees.

The scraper end portions 1b are bent inward toward the traveling direction X of the scraper 1 from the respective lateral sides of the scraper central portion 1a, and are formed into a substantially rectangular-shaped flat surface. That is, the scraper end portions 1b extend and are bent from the lateral sides of the trapezoidal shape of the scraper central portion 1a to the first contact surface side. In the scraper end portions 1b, surfaces on the traveling direction X side of the scraper 1 are surfaces that come in contact with a coating material (second contact surfaces).

The scraper end portions 1b are provided while being bent from the respective lateral sides of the trapezoidal-shaped scraper central portion 1a, thereby causing the scraper end portions 1b to be inclined relative to the first contact surface of the scraper central portion 1a. Therefore, the scraper end portions 1b are inclined in a direction from an upper side to a lower side toward the rear in the traveling direction X of the scraper 1. Accordingly, when the first contact surface of the scraper central portion 1a is set vertically to the screen plate 20, the scraper end portions 1b have an inclination angle of 90 degrees or smaller relative to the screen plate 20. Lower sides of the scraper end portions 1b are provided to be positioned on the same plane as the lower base of the scraper central portion 1a in order that when the scraper 1 slides over the screen plate 20, the whole area of the lower sides and the lower base can come into contact with a coating material on the screen plate 20.

When screen printing is performed, the scraper 1 as described above is set on the screen plate 20 in order that the first contact surface of the scraper central portion 1a is vertical to the screen plate 20, and the upper base and the lower base of the scraper central portion 1a are orthogonal to the traveling direction X of the scraper 1. By sliding the scraper 1 over the screen plate 20 in the traveling direction X of the scraper 1, the screen plate 20 is evenly coated with a coating material of paste or ink that is supplied to the screen plate 20. At this time, the second contact surfaces of the scraper end portions 1b scrape the coating material present beyond the printing pattern portion 20a in a scraper width direction, and move the coating material to the center of the scraper central portion 1a in a width direction of the scraper 1. The scraper width direction is a direction of the lower base of the scraper central portion 1a.

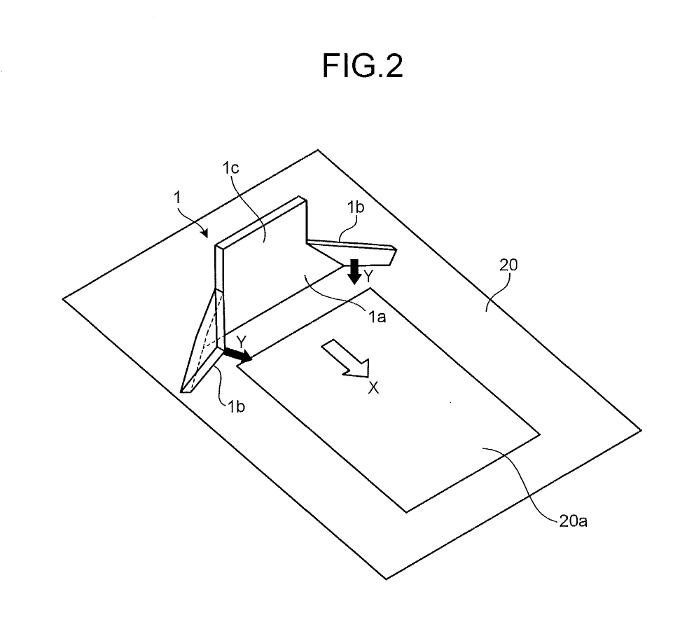

In the scraper 1 according to the first embodiment as described above, the scraper end portions 1b extend and are bent from the respective lateral sides of the trapezoidal-shaped scraper central portion 1a, thereby causing the scraper end portions 1b to be inclined. Accordingly, when the first contact surface of the scraper central portion 1a is set vertically to the screen plate 20, the second contact surfaces of the scraper end portions 1b have an inclination angle of 90 degrees or smaller relative to the screen plate 20. When the scraper 1 as described above is slid in the traveling direction X of the scraper 1, a force diagonal to the traveling direction X of the scraper 1 (a force directed toward the scraper central portion 1a in the width direction of the scraper 1), as shown by arrows Y in FIG. 2, is applied to a coating material scraped near a boundary between the scraper central portion 1a and the scraper end portions 1b, and by the scraper end portions 1b. Therefore, there is an effect of reducing a flow of the coating material over and around the scraper end portions 1b to the outside of the scraper 1. FIG. 2 is a schematic diagram for explaining a force applied to a coating material scraped by the scraper end portions 1b in the scraper 1 according to the first embodiment.

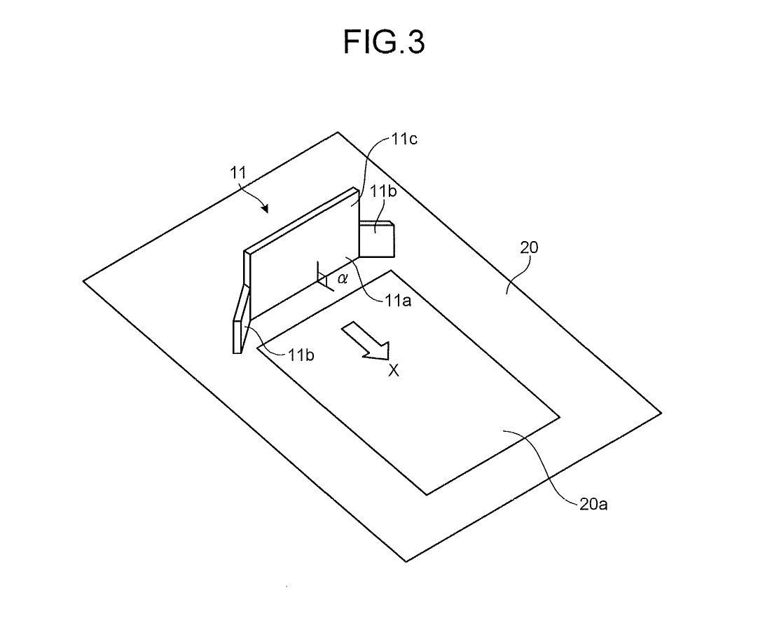

FIG. 3 is a perspective view of an external appearance of a conventional general scraper 11. In the scraper 11 shown in FIG. 3, flat scraper end portions 11b provided at both end portions of the scraper 11 are formed integrally with a flat scraper central portion 11a provided at the center of the scraper 11. In the scraper 11, a surface on a traveling direction X side of the scraper is a contact surface with a coating material. The scraper end portions 11b are bent inward toward the traveling direction X of the scraper 11 from respective lateral sides of the scraper central portion 11a, and are formed into a substantially rectangular-shaped flat surface. On an upper base of the scraper central portion 11a, an attachment portion 11c attached to a scraper holder (not shown) that attaches the scraper 11 to a screen printing device is provided to extend upward in the plane direction of the scraper central portion 11a. The scraper 11 is used in a state where the scraper central portion 11a and the scraper end portions 11b are set vertically to the screen plate 20.

Other than Patent Literatures 1 to 4 described above, Japanese Patent Application Laid-open No. 4-341846 and Japanese Utility Model Laid-open Publication No. 62-094036 also describe an example of a conventional scraper in which a scraper central portion is set at an attack angle of 90 degrees or smaller.

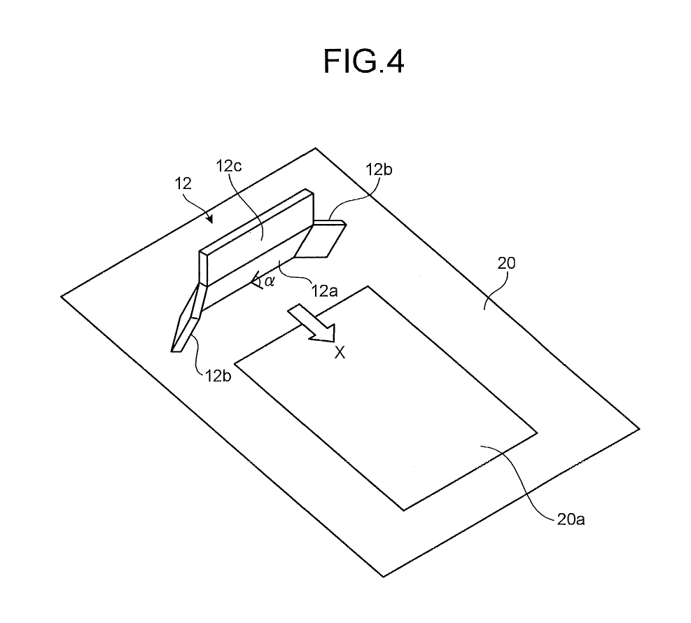

When the conventional general scraper 11 as described above is combined with a technique of forming an attack angle at 90 degrees or smaller, which is described in Japanese Patent Application Laid-open No. 4-341846, a scraper 12 having a structure as shown in FIG. 4 is obtained. FIG. 4 is a perspective view of an external appearance of the scraper 12 in which a conventional general scraper is combined with the technique described in Japanese Patent Application Laid-open No. 4-341846. In the scraper 12, scraper end portions 12b have an inclination angle of 90 degrees or smaller relative to the screen plate 20. Therefore, the scraper 12 can be expected to have an effect of reducing a flow of a coating material over and around the scraper end portions 12b to outside of the scraper 12. However, a significant difference between the scraper 1 according to the first embodiment and the scraper 12 is a behavior of a coating material scraped near a boundary between a scraper central portion and scraper end portions.

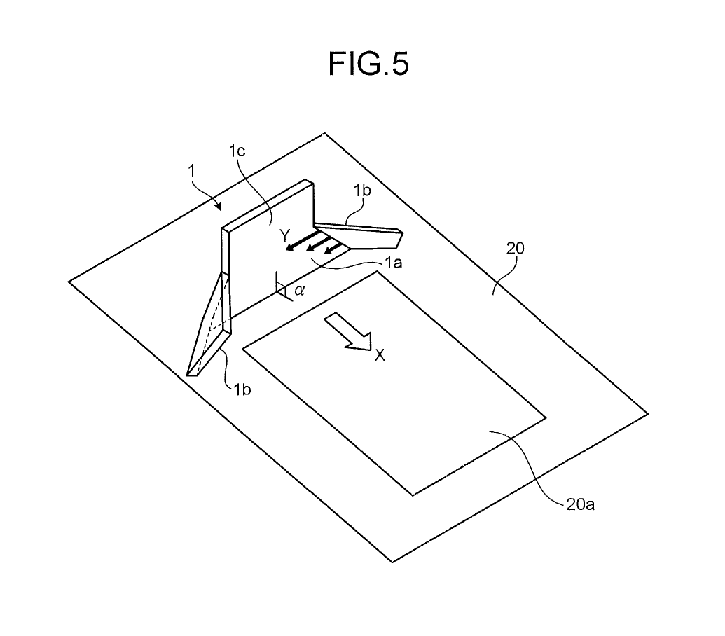

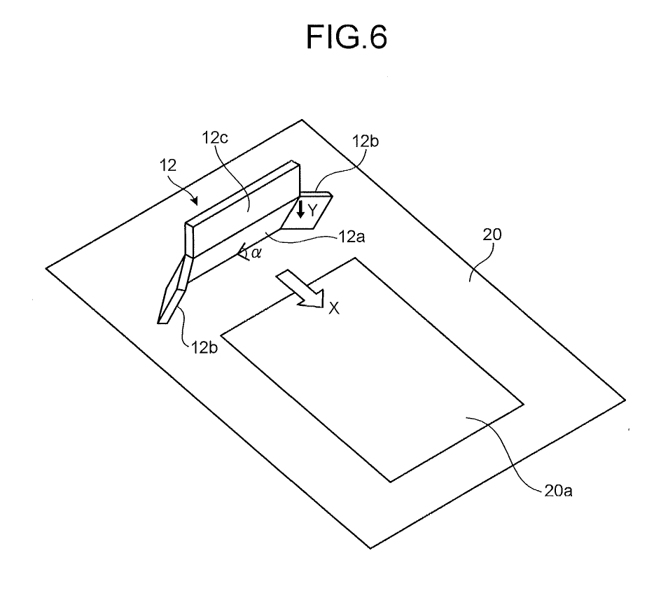

The difference between the scraper 1 according to the first embodiment and the scraper 12 is explained with reference to FIGS. 5 and 6. FIG. 5 is an explanatory diagram of a force applied to a coating material scraped near a boundary between the scraper central portion 1a and the scraper end portions 1b in the scraper 1 according to the first embodiment. FIG. 6 is an explanatory diagram of the scraper 12, in which a force is applied to a coating material scraped near a boundary between a scraper central portion 12a and the scraper end portions 12b.

In the scraper 12, a force diagonal to the traveling direction X of a scraper is applied to a coating material scraped by the scraper end portions 12b. Although a downward force shown by an arrow Y in FIG. 6 is applied to a coating material scraped near the boundary between the scraper central portion 12a and the scraper end portions 12b, a lateral-direction force is not applied thereto. Therefore, the coating material scraped by this area only moves while being rolled in the traveling direction X of the scraper. That is, the coating material scraped near the boundary between the scraper central portion 12a and the scraper end portions 12b is rolled back on the screen plate 20. This coating material is scraped again near the boundary between the scraper central portion 12a and the scraper end portions 12b, and only moves in the traveling direction X of the scraper. In this case, when an amount of the coating material scraped by the scraper 12 is increased, the coating material is not really prevented from flowing over and around the scraper end portions 12b to the outside of the scraper 12.

On the other hand, the scraper 1 according to the first embodiment includes the trapezoidal-shaped scraper central portion 1a and the scraper end portions 1b that extend and are bent inward toward the traveling direction X of the scraper 1 from the respective lateral sides of the scraper central portion 1a. Therefore, as shown by the arrows Y in FIG. 5, a force is applied to a coating material scraped by a boundary portion between the scraper central portion 1a and the scraper end portions 1b to move the coating material to the center of the scraper central portion 1a in the width direction of the scraper 1. This force increases as there are more deposits of a coating material. Therefore, in the scraper 1 according to the first embodiment, an effect of moving the coating material, scraped by the boundary portion between the scraper central portion 1a and the scraper end portions 1b, to the center of the scraper central portion 1a in the width direction of the scraper 1 is more significant than that in the scraper 12 in which the conventional scraper 11 is solely combined with the technique described in Japanese Patent Application Laid-open No. 4-341846. That is, in the scraper 1, an effect of reducing a flow of a coating material over and around the scraper end portions 1b to the outside of the scraper 1 is substantially enhanced as compared to that in the scraper 12.

As described above, the scraper 1 according to the first embodiment includes the trapezoidal-shaped scraper central portion 1a and the scraper end portions 1b that extend and are bent inward toward the traveling direction X of the scraper 1 from the respective lateral sides of the trapezoidal-shaped scraper central portion 1a. Accordingly, the scraper 1 can apply a force to a coating material scraped by the boundary portion between the scraper central portion 1a and the scraper end portions 1b to move the coating material in a direction of the center of the scraper central portion 1a in the width direction of the scraper 1. Therefore, the scraper 1 according to the first embodiment can reliably reduce a flow of the coating material over and around the scraper end portions 1b to the outside of the scraper 1.

Further, the scraper 1 according to the first embodiment is formed integrally by changing a scraper shape itself in contrast to the proposals in Patent Literatures 1 to 4 in which new members are added to an existing configuration. Therefore, the scraper 1 can be manufactured simply from, for example, one metal sheet at a low cost, similarly to a conventional general scraper. To obtain the above effects of the scraper 1, it suffices that contact surfaces with a coating material satisfy the conditions described above. Therefore, a configuration on a back side of the scraper 1, that is, a configuration of a surface on the opposite side to the traveling direction X is not particularly limited.

### Second Embodiment

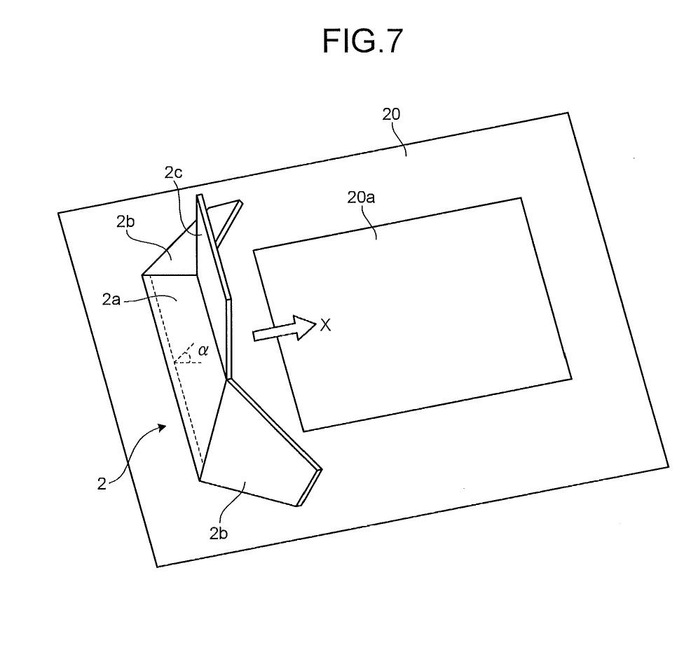

FIG. 7 is a perspective view of an external appearance of a screen printing device scraper 2 according to a second embodiment of the present invention. The scraper 2 according to the second embodiment has a structure, with the scraper 1 according to the first embodiment as a basic configuration, in which a scraper central portion 2a is inclined in order that the attack angle α is an acute angle. That is, the scraper 2 according to the second embodiment includes the trapezoidal-shaped scraper central portion 2a and scraper end portions 2b that extend and are bent inward toward a traveling direction X of the scraper 2 from respective lateral sides of the scraper central portion 2a. On an upper base of the scraper central portion 2a, an attachment portion 2c attached to a scraper holder (not shown) that attaches the scraper 2 to a screen printing device is provided to extend upward. When the scraper central portion 2a is set on the screen plate 20, the attack angle α that is an angle formed between a contact surface with a coating material and the screen plate 20 is an acute angle.

In the scraper 2 according to the second embodiment as described above, because the attack angle a is an acute angle, a scraped coating material is easily rolled, and an amount of the coating material filled in a pattern provided on the screen plate 20 is increased. As a result, there is an effect of easily obtaining a desired printing shape.

Further, in the scraper 2 according to the second embodiment, even when the attack angle α is an acute angle, an effect of moving a coating material to the scraper central portion 2a, which is obtained from the scraper end portions 2b and near a boundary between the scraper central portion 2a and the scraper end portions 2b, remains unchanged as compared to that in the scraper 1 according to the first embodiment. Therefore, the scraper 2 according to the second embodiment can reliably reduce a flow of a coating material over and around the scraper end portions 2b to the outside of the scraper 2, similarly to the scraper 1 according to the first embodiment.

Further, the scraper 2 according to the second embodiment is also formed integrally by changing a scraper shape itself in contrast to the proposals in Patent Literatures 1 to 4 in which new members are added to an existing configuration. Therefore, the scraper 2 can be manufactured simply from, for example, one metal sheet at a low cost, similarly to a conventional general scraper.

### INDUSTRIAL APPLICABILITY

As described above, the screen printing device scraper according to the present invention is useful in reducing the material loss and cost in screen printing.

### REFERENCE SIGNS LIST

1 scraper
1a scraper central portion
1b scraper end portion
1c attachment portion to scraper holder
2 scraper
2a scraper central portion
2b scraper end portion
2c attachment portion to scraper holder
11 scraper
11a scraper central portion
11b scraper end portion
11c attachment portion to scraper holder
12 scraper
12a scraper central portion
12b scraper end portion
20 screen plate
20a printing pattern portion
α attack angle

1. A scraper for a screen printing device that slides in a predetermined direction over a surface of a flat screen plate on which a coating material is supplied to coat the coating material on the surface of the screen plate, the screen printing device scraper comprising:
a scraper central portion in which a first contact surface that comes in contact with the coating material has a trapezoidal shape with a lower base longer than an upper base; and
scraper end portions that extend and are bent from respective lateral sides of a trapezoidal shape of the scraper central portion to a side of the first contact surface, and that include second contact surfaces that come in contact with the coating material, wherein
a lower base of the scraper central portion and lower sides of the scraper end portions are on a same plane, and
in a state where the first contact surface is vertical to the surface of the screen plate, the lower base of the scraper central portion and the lower sides of the scraper end portions come in contact with the coating material on the surface of the screen plate, and slide on the surface of the screen plate.

2. The screen printing device scraper according to claim 1, wherein the screen printing device scraper is formed integrally from one metal plate.

3. A scraper for a screen printing device that slides in a predetermined direction over a surface of a flat screen plate on which a coating material is supplied to coat the coating material on the surface of the screen plate, the screen printing device scraper comprising:
a scraper central portion in which a first contact surface that comes in contact with the coating material has a trapezoidal shape with a lower base longer than an upper base; and
scraper end portions that extend and are bent from respective lateral sides of a trapezoidal shape of the scraper central portion to a side of the first contact surface, and that include second contact surfaces that come in contact with the coating material, wherein
a lower base of the scraper central portion and lower sides of the scraper end portions are on a same plane, and
in a state where the first contact surface forms an acute angle relative to the surface of the screen plate, the lower base of the scraper central portion and the lower sides of the scraper end portions come in contact with the coating material on the surface of the screen plate, and slide on the surface of the screen plate.

4. The screen printing device scraper according to claim 3, wherein the screen printing device scraper is formed integrally from one metal plate.
